(19) United States
(12) Patent Application Publication
(10) Pub. No.: US 2026/0284570 A1
(43) Pub. Date: Sep. 24, 2026

(54) METHOD FOR REMOVING HYDROGEN FLUORIDE

(71) Applicant: Resonac Corporation, Tokyo (JP)

(72) Inventors: Riku KANAUCHI, Tokyo (JP); Yohsuke FUKUCHI, Tokyo (JP); Hiroshi KOBAYASHI, Tokyo (JP)

(73) Assignee: Resonac Corporation, Tokyo (JP)

(21) Appl. No.: 19/479,824

(22) PCT Filed: Dec. 3, 2024
(86) PCT No.: PCT/JP2024/042743

§ 371 Date: Oct. 29, 2025

(30) Foreign Application Priority Data
Dec. 14, 2023 (JP) 2023-211542

(51) Int. Cl. B01D 53/04

(52) U.S. Cl. CPC B01D 53/0438; B01D 2253/112; B01D 2257/2047; B01D 2259/4009; B01D 2259/402

(57) ABSTRACT

A method for removing hydrogen fluoride includes: a first adsorption step of introducing gas to be treated into a first adsorption treatment section including sodium fluoride, bringing the gas to be treated into contact with the sodium fluoride, and allowing the hydrogen fluoride in the gas to be treated to adsorb on the sodium fluoride to obtain first adsorption-treated gas; and a second adsorption step of introducing the first adsorption-treated gas into a second adsorption treatment section including sodium fluoride, bringing the first adsorption-treated gas into contact with the sodium fluoride, and allowing the hydrogen fluoride in the first adsorption-treated gas to adsorb on the sodium fluoride to obtain second adsorption-treated gas. The temperature of the sodium fluoride of the first adsorption treatment section in the first adsorption step is higher than the temperature of the sodium fluoride of the second adsorption treatment section in the second adsorption step.

### TECHNICAL FIELD

The present disclosure relates to a method for removing hydrogen fluoride.

### BACKGROUND ART

Gases of fluorine-containing compounds, such as fluorine gas, interhalogen compounds (e.g., chlorine monofluoride and chlorine trifluoride), tungsten hexafluoride, silicon tetrafluoride, nitrogen trifluoride, and sulfur tetrafluoride, are useful as gases for use in the manufacture of semiconductors, but contain hydrogen fluoride as impurities in many cases.

PTLS 1, 2 disclose technology of removing hydrogen fluoride from the gases of the fluorine-containing compounds by allowing hydrogen fluoride to adsorb on sodium fluoride for purification.

### CITATION LIST

### Patent Literatures

PTL 1: JP 6792158 B
PTL 2: JP 4843635 B

### SUMMARY OF INVENTION

### Technical Problem

However, sodium fluoride has had the problem of causing early breakthrough due to having a hydrogen fluoride adsorption capacity smaller than that of activated carbon as a common adsorbent. Therefore, when the hydrogen fluoride concentration in gas to be treated, which is subjected to hydrogen fluoride removal treatment, is high, the sodium fluoride as an adsorbent has been required to be frequently exchanged. Thus, it has not been easy to remove hydrogen fluoride in gas to be treated having a high hydrogen fluoride concentration by the sodium fluoride until the hydrogen fluoride concentration becomes low.

It is an object of the present disclosure to provide a method for removing hydrogen fluoride capable of removing hydrogen fluoride from gas to be treated until the hydrogen fluoride concentration becomes a low concentration using sodium fluoride, even when the gas to be treated has a high hydrogen fluoride concentration.

### Solution to Problem

To solve the above-described problem, one aspect of the present disclosure is as described in [1] to [11] below.
[1]A method for removing hydrogen fluoride from gas to be treated containing the hydrogen fluoride, including:
a first adsorption step of introducing the gas to be treated into a first adsorption treatment section including sodium fluoride, bringing the gas to be treated into contact with the sodium fluoride of the first adsorption treatment section, and allowing the hydrogen fluoride in the gas to be treated to adsorb on the sodium fluoride of the first adsorption treatment section to obtain first adsorption-treated gas, the first adsorption-treated gas being the gas to be treated in which a hydrogen fluoride concentration has been lowered; and
a second adsorption step of introducing the first adsorption-treated gas into a second adsorption treatment section including sodium fluoride, bringing the first adsorption-treated gas into contact with the sodium fluoride of the second adsorption treatment section, and allowing the hydrogen fluoride in the first adsorption-treated gas to adsorb on the sodium fluoride of the second adsorption treatment section to obtain second adsorption-treated gas, the second adsorption-treated gas being the first adsorption-treated gas in which the hydrogen fluoride concentration has been lowered, in which
the temperature of the sodium fluoride of the first adsorption treatment section when the gas to be treated is brought into contact with the sodium fluoride in the first adsorption step is higher than the temperature of the sodium fluoride of the second adsorption treatment section when the first adsorption-treated gas is brought into contact with the sodium fluoride in the second adsorption step,
in the first adsorption step, a ratio of the mass of the hydrogen fluoride per unit time in the gas to be treated introduced into the first adsorption treatment section to the mass of the sodium fluoride of the first adsorption treatment section before the adsorption is 0.05 HF-mg/NaF-g/h or more and 70 HF-mg/NaF-g/h or less, and
in the second adsorption step, a ratio of the mass of the hydrogen fluoride per unit time in the first adsorption-treated gas introduced into the second adsorption treatment section to the mass of the sodium fluoride of the second adsorption treatment section before the adsorption is 0.001 HF-mg/NaF-g/h or more and 5 HF-mg/NaF-g/h or less.
[2] The method for removing hydrogen fluoride according to [1], further including:
a desorption step of heating at least one of the sodium fluoride of the first adsorption treatment section used in the first adsorption step and the sodium fluoride of the second adsorption treatment section used in the second adsorption step under heat treatment atmospheric gas, and desorbing the hydrogen fluoride at a rate of 10 mg or less per gram of the sodium fluoride before the adsorption and 10 mg or less per minute in each of the sodium fluoride of the first adsorption treatment section and the sodium fluoride of the second adsorption treatment section; and
an exchange step of exchanging at least one of the sodium fluoride of the first adsorption treatment section used in the first adsorption step and the sodium fluoride of the second adsorption treatment section used in the second adsorption step with the sodium fluoride from which the hydrogen fluoride has been desorbed in the desorption step.
[3] The method for removing hydrogen fluoride according to [1] or [2], in which the temperature of the sodium fluoride of the first adsorption treatment section when the gas to be treated is brought into contact with the sodium fluoride in the first adsorption step is 50° C. or more and 120° C. or less.
[4] The method for removing hydrogen fluoride according to any one of [1] to [3], in which the temperature of the sodium fluoride of the second adsorption treatment section when the first adsorption-treated gas is brought into contact with the sodium fluoride in the second adsorption step is −10° C. or more and less than 50° C.
[5] The method for removing hydrogen fluoride according to any one of [1] to [4], in which, in the first adsorption step, the ratio of the mass of the hydrogen fluoride in the gas to be treated introduced into the first adsorption treatment section to the mass of the sodium fluoride of the first adsorption treatment section before the adsorption is 10 HF-mg/NaF-g or more and 100 HF-mg/NaF-g or less.
[6] The method for removing hydrogen fluoride according to any one of [1] to [5], in which, in the second adsorption step, the ratio of the mass of the hydrogen fluoride in the first adsorption-treated gas introduced into the second adsorption treatment section to the mass of the sodium fluoride of the second adsorption treatment section before the adsorption is 100 HF-mg/NaF-g or less.
[7] The method for removing hydrogen fluoride according to [2], in which the heating temperature of the desorption step is 150° C. or more and 240° C. or less.
[8] The method for removing hydrogen fluoride according to [2] or [7], in which the heat treatment atmospheric gas is at least one of nitrogen gas, helium, argon, oxygen gas, and air.
[9] The method for removing hydrogen fluoride according to any one of [1] to [8], in which the hydrogen fluoride concentration in the second adsorption-treated gas discharged from the second adsorption treatment section is 0.01 ppm by volume or more and 250 ppm by volume or less.
[10] The method for removing hydrogen fluoride according to any one of [1] to [9], in which the gas to be treated contains at least one of fluorine gas, chlorine monofluoride, chlorine trifluoride, chlorine pentafluoride, bromine trifluoride, bromine pentafluoride, bromine heptafluoride, iodine trifluoride, iodine pentafluoride, iodine heptafluoride, tungsten hexafluoride, silicon tetrafluoride, nitrogen trifluoride, and sulfur tetrafluoride, and hydrogen fluoride.
[11] The method for removing hydrogen fluoride according to any one of [1] to [10], in which the sodium fluoride of the first adsorption treatment section and the sodium fluoride of the second adsorption treatment section are obtained by tableting and molding sodium fluoride powder.

### Advantageous Effects of Invention

According to the present disclosure, even when the gas to be treated has a high hydrogen fluoride concentration, the hydrogen fluoride can be removed from the gas to be treated until the hydrogen fluoride concentration becomes a low concentration using sodium fluoride.

### BRIEF DESCRIPTION OF DRAWINGS

FIG. 1 is a graph showing one example of the transition of the hydrogen fluoride concentration of outlet gas of a sodium fluoride packed column;

FIG. 2 is a schematic view illustrating one example of a hydrogen fluoride removal device illustrating one embodiment of a method for removing hydrogen fluoride according to the present disclosure; and

FIG. 3 is a schematic view illustrating one example of a desorption device performing a desorption step.

### DESCRIPTION OF EMBODIMENTS

Embodiments of the present disclosure will now be described. The embodiments are merely examples of the present disclosure, and the present disclosure is not limited to the embodiments. Various modifications or improvements can be made in the embodiments, and such modifications and improvements can be encompassed by the present disclosure.

Conventionally, sodium fluoride (NaF) pellets used as an adsorbent of hydrogen fluoride (HF) have been obtained by tableting and heat-molding sodium fluoride powder (aggregate of sodium fluoride crystals). The pellets have been molded at a high tableting pressure and fired at a high temperature to reduce brittleness. Therefore, the specific surface area of the sodium fluoride pellets has been small, and thus the hydrogen fluoride adsorption capacity has been small.

The present inventors have repeatedly conducted extensive studies to solve the above-described problem of the sodium fluoride pellets, and have analyzed how the sodium fluoride pellets and hydrogen fluoride interact with each other, and thus have reached the present disclosure. The contents and the results of the studies by the present inventors are described below.

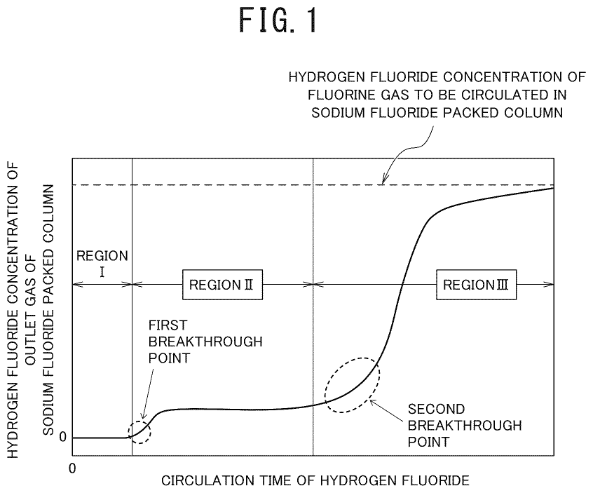

In a sodium fluoride packed column packed with the sodium fluoride pellets, fluorine gas containing 10% by volume of hydrogen fluoride was circulated, and the hydrogen fluoride concentration of outlet gas discharged from an outlet of the sodium fluoride packed column was analyzed. FIG. 1 illustrates a representative example of a curve plotting the transition of the hydrogen fluoride concentration of the outlet gas. Although the details are described later, the behavior of the removal of the hydrogen fluoride by the sodium fluoride pellets will be described referring to FIG. 1.

For a while after the fluorine gas containing hydrogen fluoride has started to circulate in the sodium fluoride packed column, the hydrogen fluoride concentration of the outlet gas was equal to or less than the detection lower limit value of a detection device, or, even when detected, the amount was very small. Hereinafter, this region is referred to as a “Region I”.

When the fluorine gas containing hydrogen fluoride was further supplied to the sodium fluoride packed column, the hydrogen fluoride was detected from the outlet gas, and the hydrogen fluoride concentration increased. This point is equivalent to a first breakthrough point (point where a sharp increase in the hydrogen fluoride is first observed in successive changes of a breakthrough curve).

The hydrogen fluoride concentration of the outlet gas after passing the first breakthrough point increased, but was much lower than the hydrogen fluoride concentration of the fluorine gas supplied to the sodium fluoride packed column. Then, the present inventors have found that, after that, a period of time while the hydrogen fluoride concentration of the outlet gas does not increase continues for a fixed period of time. Hereinafter, this region is referred to as a “region II” (see FIG. 1).

In adsorption by a common adsorbent (e.g., activated carbon), the breakthrough point is the point where the hydrogen fluoride concentration at the first breakthrough point starts to increase, and, after the breakthrough, the hydrogen fluoride concentration continues to linearly increase to reach the hydrogen fluoride concentration of the fluorine gas supplied to the sodium fluoride packed column. However, the present inventors have found that there is a region exhibiting a plateau curve with a slow increase in the hydrogen fluoride concentration after the first breakthrough point.

When the supply of the fluorine gas was further continued subsequent to the region II, a second breakthrough point appeared (point where a sharp increase in the hydrogen fluoride concentration appeared second in successive changes of the breakthrough curve) where the hydrogen fluoride concentration of the outlet gas starts to further increase. After that, the hydrogen fluoride concentration of the outlet gas continued to increase, and a value close to the hydrogen fluoride concentration of the fluorine gas supplied to the sodium fluoride packed column was exhibited. Hereinafter, this region is referred to as a “region III” (see FIG. 1).

Due to differences in the specific surface area, the average pore size, and the pore size distribution of the sodium fluoride pellets, a difference appears in the durations of the region I and the region II.

Although the mechanism is not clear, it is presumed that, in the region I, the hydrogen fluoride is constrained to the surfaces of the sodium fluoride crystals and almost the entire amount of the hydrogen fluoride is fixed to the surfaces of the sodium fluoride crystals. Similarly, although the mechanism is not clear, it is presumed that, in the region II, the hydrogen fluoride constrained to the surfaces is diffused into the sodium fluoride crystals, forming a salt compound of the hydrogen fluoride and the sodium fluoride.

A method for removing hydrogen fluoride according to this embodiment is a method for removing hydrogen fluoride from gas to be treated containing hydrogen fluoride, including: a first adsorption step of introducing the gas to be treated into a first adsorption treatment section including sodium fluoride, bringing the gas to be treated into contact with the sodium fluoride of the first adsorption treatment section, and allowing the hydrogen fluoride in the gas to be treated to adsorb on the sodium fluoride of the first adsorption treatment section to obtain first adsorption-treated gas, the first adsorption-treated gas being the gas to be treated in which the hydrogen fluoride concentration has been lowered; and a second adsorption step of introducing the first adsorption-treated gas into a second adsorption treatment section including sodium fluoride, bringing the first adsorption-treated gas into contact with the sodium fluoride of the second adsorption treatment section, and allowing the hydrogen fluoride in the first adsorption-treated gas to adsorb on the sodium fluoride of the second adsorption treatment section to obtain second adsorption-treated gas, the second adsorption-treated gas being the first adsorption-treated gas in which the hydrogen fluoride concentration has been lowered.

The temperature of the sodium fluoride of the first adsorption treatment section when the gas to be treated is brought into contact with the sodium fluoride in the first adsorption step is higher than the temperature of the sodium fluoride of the second adsorption treatment section when the first adsorption-treated gas is brought into contact with the sodium fluoride in the second adsorption step.

In the first adsorption step, the ratio of the mass of the hydrogen fluoride per unit time in the gas to be treated introduced into the first adsorption treatment section to the mass of the sodium fluoride of the first adsorption treatment section before the adsorption is 0.05 HF-mg/NaF-g/h or more and 70 HF-mg/NaF-g/h or less.

In the second adsorption step, the ratio of the mass of the hydrogen fluoride per unit time in the first adsorption-treated gas introduced into the second adsorption treatment section to the mass of the sodium fluoride of the second adsorption treatment section before the adsorption is 0.001 HF-mg/NaF-g/h or more and 5 HF-mg/NaF-g/h or less.

The first adsorption step will be described. The details are described in Comparative Examples 1, 2, 3 below, and the amount of the hydrogen fluoride that can be removed in the region I from the fluorine gas containing 10% by volume hydrogen fluoride is 0.3% by mass of the mass of the packed sodium fluoride at 30° C., and when the temperature in the adsorption is increased, the removal hydrogen fluoride amount further decreases. In this adsorption amount, the method for removing hydrogen fluoride by sodium fluoride cannot be industrially used.

As a method for increasing the adsorption amount of the hydrogen fluoride, it is considered to increase the amount of the sodium fluoride to be used and reduce the temperature of the sodium fluoride packed column. However, the present inventors have found a novel method not using the above-described methods. More specifically, the sodium fluoride packed column is multistaged, the temperature of the sodium fluoride of a first sodium fluoride packed column is increased and the adsorption up to the second breakthrough point is performed in the first sodium fluoride packed column, and then the temperature of the sodium fluoride in a second sodium fluoride packed column is reduced to be lower than that of the first column. This method can reduce the hydrogen fluoride concentration in the gas to be treated to 0.01 ppm by volume or more and 250 ppm by volume or less without excessively increasing the amount of the sodium fluoride to be used. More specifically, the hydrogen fluoride concentration in the second adsorption-treated gas discharged from the second adsorption treatment section can be set to 0.01 ppm by volume or more and 250 ppm by volume or less.

When the sodium fluoride is allowed to absorb a large amount of hydrogen fluoride, there is a risk that pellets or granular materials of the sodium fluoride are joined or powdered. As a result of studies by the present inventors, the present inventors have found that, when the contact of the hydrogen fluoride with the sodium fluoride is finished before the second breakthrough point is reached, the joining or the powdering can be suppressed. In contrast thereto, in the region III at and after the second breakthrough point, the joining of pellets or granular materials of the sodium fluoride is likely to occur.

The type of the gas to be treated from which hydrogen fluoride can be removed by the method for removing hydrogen fluoride according to this embodiment is not particularly limited insofar as it contains hydrogen fluoride and does not react with sodium fluoride, and may be gas of a fluorine-containing compound containing hydrogen fluoride. The fluorine-containing compound includes, for example, fluorine gas (F₂), interhalogen compounds, tungsten hexafluoride (WF₆), silicon tetrafluoride (SiF₄), nitrogen trifluoride (NF₃), and sulfur tetrafluoride (SF₄). The interhalogen compounds include, for example, chlorine monofluoride (ClF), chlorine trifluoride (ClF₃), chlorine pentafluoride (ClF₅), bromine trifluoride (BrF₃), bromine pentafluoride (BrF₅), bromine heptafluoride (BrF₇), iodine trifluoride (IF₃), iodine pentafluoride (IF₅), and iodine heptafluoride (IF₇).

More specifically, the gas to be treated can be gas containing at least one of fluorine gas, chlorine monofluoride, chlorine trifluoride, chlorine pentafluoride, bromine trifluoride, bromine pentafluoride, bromine heptafluoride, iodine trifluoride, iodine pentafluoride, iodine heptafluoride, tungsten hexafluoride, silicon tetrafluoride, nitrogen trifluoride, and sulfur tetrafluoride, and hydrogen fluoride.

The hydrogen fluoride concentration in the gas to be treated is not particularly limited, and is preferably 20% by volume or less and more preferably 3% by volume or more and 10% by volume or less.

The form of the sodium fluoride used in the first adsorption treatment section and the second adsorption treatment section of the method for removing hydrogen fluoride according to this embodiment is not particularly limited, and includes a granular material, powder, a lump material, or the like, for example.

The shape of the sodium fluoride granular material is not particularly limited, and includes a columnar shape, a spherical shape, an oval spherical shape, and a plate shape, for example, and is preferably a cylindrical columnar pellet shape.

The size of the sodium fluoride granular material is not particularly limited. In the case of cylindrical columnar pellets, the diameter may be set to 2 mm or more and 10 mm or less, and the height may be set to 2 mm or more and 10 mm or less.

As the sodium fluoride pellets, a commercially available product (e.g., manufactured by Morita Chemical Co., Ltd.) may be used or one obtained by tableting, molding, and firing sodium fluoride powder may be used. More specifically, the sodium fluoride of the first adsorption treatment section and the sodium fluoride of the second adsorption treatment section may be those obtained by tableting and molding sodium fluoride powder.

The apparent density of one sodium fluoride granular material (value obtained by dividing the mass of one sodium fluoride granular material by the geometric volume) is not particularly limited, and is preferably 1.8 mL/g or more and 2.3 mL/g or less. When the apparent density is 1.8 mL/g or more and 2.3 mL/g or less, the sodium fluoride granular material has high crushing strength and is less likely to be powdered, and is not required to be molded at high tableting pressure, and therefore the productivity of the sodium fluoride granular material is excellent.

The container shape of the first adsorption treatment section used in the first adsorption step, i.e., the sodium fluoride packed column on a first stage, is not particularly limited, and may be a cylindrical container when the sodium fluoride granular materials are packed, for example.

The diameter of the cylindrical container is not particularly limited, and is preferably large enough for 10 or more sodium fluoride granular materials to be present in the cross section appearing when the cylindrical container is cut along a plane along the diameter direction of the cylinder, more preferably large enough for 20 or more sodium fluoride granular materials to be present, and still more preferably large enough 40 or more sodium fluoride granular materials to be present.

The height (length) of the cylindrical container is not particularly limited, and may be approximately the same length as the diameter of the container or may be a length several times or more and several tens of times or less of the diameter of the container.

A material forming the sodium fluoride packed column is preferably a material having corrosion-resistant to gas to be circulated (e.g., gas of the fluorine-containing compound) and hydrogen fluoride. Specific examples include metals, such as nickel (Ni), Hastelloy (trade name), Monel (trade name), stainless steel, copper (Cu), and soft steel.

The temperature of the sodium fluoride of the first adsorption treatment section when the gas to be treated is brought into contact with sodium fluoride in the first adsorption step is preferably 50° C. or more and 120° C. or less, with the lower limit value being more preferably 60° C. or more and the upper limit value being more preferably 100° C. or less. When the temperature is 50° C. or more, the amount of the hydrogen fluoride adsorbed on the surface of the sodium fluoride is likely to be an appropriate amount, and therefore a phenomenon in which contact parts of the sodium fluoride melt and adhere to each other is difficult to occur. When the temperature is 120° C. or less, the amount of the hydrogen fluoride that can be adsorbed up to the second breakthrough point is likely to be large.

In the first adsorption step, the ratio of the mass of the hydrogen fluoride in the gas to be treated introduced into the first adsorption treatment section to the mass of the sodium fluoride of the first adsorption treatment section before the adsorption is preferably 10 HF-mg/NaF-g or more and 100 HF-mg/NaF-g or less, with the lower limit value being more preferably 20 HF-mg/NaF-g or more and still more preferably 30 HF-mg/NaF-g or more and the upper limit value being more preferably 90 HF-mg/NaF-g or less and still more preferably 80 HF-mg/NaF-g or less.

When the ratio is 10 HF-mg/NaF-g or more and 100 HF-mg/NaF-g or less, the phenomenon in which contact parts of the sodium fluoride melt and adhere to each other is difficult to occur in addition to the fact that the hydrogen fluoride adsorption capacity becomes large.

In the first adsorption step, the ratio of the mass of the hydrogen fluoride per unit time in the gas to be treated introduced into the first adsorption treatment section to the mass of the sodium fluoride of the first adsorption treatment section before the adsorption is 0.05 HF-mg/NaF-g/h or more and 70 HF-mg/NaF-g/h or less, with 0.05 HF-mg/NaF-g/h or more and 60 HF-mg/NaF-g/h or less being preferable and 0.05 HF-mg/NaF-g/h or more and 50 HF-mg/NaF-g/h or less being more preferable.

When the ratio is 0.05 HF-mg/NaF-g/h or more and 70 HF-mg/NaF-g/h or less, the amount of the hydrogen fluoride absorbed up to the second breakthrough point is likely to be appropriate.

Further, in the first adsorption step, the space velocity (hereinafter sometimes referred to as “SV”) of the gas to be treated supplied to the first adsorption treatment section is not particularly limited, and is preferably 10 (/h) or more and 500 (/h) or less and more preferably 15 (/h) or more and 300 (/h) or less. When the SV is 10 (/h) or more and 500 (/h) or less, the amount of the hydrogen fluoride absorbed up to the second breakthrough point is likely to be appropriate.

The pressure in the first adsorption step is not particularly limited, and the first adsorption step is preferably carried out at pressure around the atmospheric pressure. In the case of normal pressure, the SV of the gas to be treated supplied to the first adsorption treatment section is likely to be a suitable value.

Further, in the first adsorption step, the amount of the hydrogen fluoride to be allowed to adsorb on the sodium fluoride up to the second breakthrough point is preferably 2% by mass or more and 15% by mass or less and more preferably 4% by mass or more and 11% by mass or less of the mass of the sodium fluoride of the first adsorption treatment section before the adsorption. When the amount is 2% by mass or more and 15% by mass or less, the phenomenon in which contact parts of the sodium fluoride melt and adhere to each other is difficult to occur in addition to the fact that the hydrogen fluoride adsorption capacity becomes large.

Next, the second adsorption step will be described. In the second adsorption step, the adsorption of the hydrogen fluoride up to the first breakthrough point is performed. The hydrogen fluoride adsorption capacity is affected by the hydrogen fluoride concentration of inlet gas (first adsorption-treated gas, which is the gas to be treated supplied to the second adsorption treatment section) of the sodium fluoride packed column of the second adsorption step.

In the case of a common adsorbent, when deterioration, for example, of the adsorbent is neglected, a fixed amount of an adsorbate is adsorbed on a fixed number of adsorption sites, and therefore the amount of the adsorbate that can be adsorbed is approximately constant. In contrast thereto, the present inventors have found that, in the adsorption (absorption) of the hydrogen fluoride to the sodium fluoride, the hydrogen fluoride concentration of a gas phase causes a large difference in the amount of the hydrogen fluoride that can be adsorbed up to the first breakthrough point.

As described in Example 6 described later, the lower the hydrogen fluoride concentration in the gas to be treated supplied to the sodium fluoride packed column, the larger the amount of the hydrogen fluoride adsorbed up to the first breakthrough point. This phenomenon is presumed to occur due to the balance between the rate at which the hydrogen fluoride is adsorbed on the surface of the sodium fluoride (adsorption amount) and the rate at which the hydrogen fluoride is diffused into the sodium fluoride crystals (diffusion amount).

The sodium fluoride used in the second adsorption treatment section of the method for removing hydrogen fluoride according to this embodiment is the same as the sodium fluoride used in the first adsorption treatment section, and therefore a description thereof is omitted.

Further, the second adsorption treatment section used in the second adsorption step, i.e., the sodium fluoride packed column on a second stage, is also the same as the first adsorption treatment section, i.e., the sodium fluoride packed column on the first stage, and therefore a description thereof is omitted.

The temperature of the sodium fluoride of the second adsorption treatment section when the first adsorption-treated gas is brought into sodium fluoride in the second adsorption step is preferably −10° C. or more and less than 50° C., with the lower limit value being more preferably 10° C. or more and the upper limit value being more preferably 30° C. or less. When the temperature is −10° C. or more, the amount of the hydrogen fluoride adsorbed on the surface of the sodium fluoride is likely to be an appropriate amount, and therefore the phenomenon in which contact parts of the sodium fluoride melt and adhere to each other is difficult to occur. When the temperature is less than 50° C., the amount of the hydrogen fluoride that can be adsorbed up to the first breakthrough point is likely to be large.

In the second adsorption step, the ratio of the mass of the hydrogen fluoride in the first adsorption-treated gas introduced into the second adsorption treatment section to the mass of the sodium fluoride of the second adsorption treatment section before the adsorption is preferably 100 HF-mg/NaF-g or less, more preferably 80 HF-mg/NaF-g or less, and still more preferably 50 HF-mg/NaF-g or less.

When the ratio is 100 HF-mg/NaF-g or less, the phenomenon in which contact parts of the sodium fluoride melt and adhere to each other is difficult to occur.

In the second adsorption step, the ratio of the mass of the hydrogen fluoride per unit time in the first adsorption-treated gas introduced into the second adsorption treatment section to the mass of the sodium fluoride of the second adsorption treatment section before the adsorption is 0.001 HF-mg/NaF-g/h or more and 5 HF-mg/NaF-g/h or less, with 0.001 HF-mg/NaF-g/h or more and 4 HF-mg/NaF-g/h or less being preferable and 0.001 HF-mg/NaF-g/h or more and 3 HF-mg/NaF-g/h or less being more preferable.

When the ratio is 0.001 HF-mg/NaF-g/h or more and 5 HF-mg/NaF-g/h or less, the amount of the hydrogen fluoride absorbed up to the first breakthrough point is likely to be an appropriate amount.

In the second adsorption step, the space velocity of the first adsorption-treated gas supplied to the second adsorption treatment section is not particularly limited, and is preferably 10 (/h) or more and 500 (/h) or less and more preferably 15 (/h) or more and 300 (/h) or less. When the SV is 10 (/h) or more and 500 (/h) or less, the amount of the hydrogen fluoride absorbed up to the first breakthrough point is likely to be appropriate.

The pressure in the second adsorption step is not particularly limited, and the second adsorption step is preferably carried out at pressure around the atmospheric pressure. In the case of normal pressure, the SV of the first adsorption-treated gas supplied to the second adsorption treatment section is likely to be a suitable value.

In the second adsorption step, the amount of the hydrogen fluoride to be allowed to adsorb on the sodium fluoride up to the first breakthrough point is preferably 8% by mass or less and more preferably 5% by mass or less of the mass of the sodium fluoride of the second adsorption treatment section before the adsorption. When the amount is 8% by mass or less, the phenomenon in which contact parts of the sodium fluoride melt and adhere to each other is difficult to occur.

The detection of the first breakthrough point in the second adsorption step can be performed by measuring the hydrogen fluoride, which was not able to be adsorbed by the sodium fluoride of the second adsorption treatment section, by a Fourier transform infrared spectroscopy or the like. The hydrogen fluoride concentration can be calculated from the peak at 4038 cm⁻¹, which is the absorption wavelength of the hydrogen fluoride.

By carrying out the first adsorption step and then the second adsorption step using the two adsorption treatment sections, the following effects can be obtained as is understood from Example 6 and Comparative Example 2 described later. More specifically, in Comparative Example 2, the amount of the hydrogen fluoride that can be adsorbed up to the first breakthrough point is 0.21% by mass of the mass of the sodium fluoride. Even when the amount of the sodium fluoride to be used is doubled (68 mL), 0.21% by mass of the hydrogen fluoride can be removed, and the amount of the removed hydrogen fluoride is 0.19 g/68 mL-NaF.

In contrast thereto, in Example 6, the amount of the hydrogen fluoride that can be adsorbed up to the second breakthrough point in the first adsorption step is 5.9% by mass (2.6 g in terms of mass of the hydrogen fluoride) of the mass of the sodium fluoride, and, by performing the second adsorption step using the same amount of the sodium fluoride as that of the first adsorption step, the hydrogen fluoride concentration of the outlet gas of the sodium fluoride packed column can be made non-detection.

The amount of the hydrogen fluoride removed by the second adsorption step is small, and therefore is neglected, and the amount of the hydrogen fluoride that was able to be removed in the first adsorption step and the second adsorption step is 2.6 g/68 mL-NaF. Therefore, it has been found that the removal amount of the hydrogen fluoride is 15 times (2.6/0.17) as large as the removal amount of the hydrogen fluoride up to the first breakthrough point.

Next, steps that may be performed after the second adsorption step are described. The method for removing hydrogen fluoride according to this embodiment may further include: a desorption step of heating at least one of the sodium fluoride of the first adsorption treatment section used in the first adsorption step and the sodium fluoride of the second adsorption treatment section used in the second adsorption step under heat treatment atmospheric gas, and desorbing the hydrogen fluoride at a rate of 10 mg or less per gram of the sodium fluoride before the adsorption and 10 mg or less per minute in each of the sodium fluoride of the first adsorption treatment section and the sodium fluoride of the second adsorption treatment section; and an exchange step of exchanging at least one of the sodium fluoride of the first adsorption treatment section used in the first adsorption step and the sodium fluoride of the second adsorption treatment section used in the second adsorption step with the sodium fluoride from which the hydrogen fluoride has been desorbed in the desorption step.

The sodium fluoride used in the first adsorption step or the second adsorption step can be reused in the first adsorption step and the second adsorption step after reproduction treatment (desorption step) of performing dehydrofluorination. To continuously perform the removal of the hydrogen fluoride in the gas to be treated, an auxiliary sodium fluoride packed column may be placed so that the sodium fluoride packed column used in the first adsorption step and the sodium fluoride packed column used in the second adsorption step can be switched.

The sodium fluoride packed columns used in the steps may be placed in parallel to each other. More specifically, the number of the sodium fluoride packed columns used in the first adsorption step may be two or more, and the number of the sodium fluoride packed columns used in the second adsorption step may be two or more. Alternatively, it may be acceptable that three sodium fluoride packed columns are set as one set, and operated in a series manner by using one sodium fluoride packed column for both the first adsorption step and the second adsorption step.

The sodium fluoride packed column used in the first adsorption step or the second adsorption step may be replaced with the sodium fluoride packed column reproduced by the desorption step. This replacement operation is the exchange step. The desorption step may be performed in the sodium fluoride packed column used in the first adsorption step or the second adsorption step, or may be performed in a separate place (e.g., heat treatment device) after the sodium fluoride is extracted from the sodium fluoride packed column.

The heat treatment of the desorption step can be performed by heating the sodium fluoride under heat treatment atmospheric gas. When the desorption step is performed in the sodium fluoride packed column, the sodium fluoride may be heated while the heat treatment atmospheric gas is being circulated in the sodium fluoride packed column.

The type of the heat treatment atmospheric gas is not particularly limited, and may be at least one of nitrogen gas, helium, argon, oxygen gas, and air.

The heating temperature of the desorption step may be set to 150° C. or more and 240° C. or less, and is preferably 160° C. or more and 220° C. or less and more preferably 180° C. or more and 200° C. or less. When the heating temperature is 150° C. or more and 240° C. or less, the sodium fluoride granular materials are difficult to be powdered, and the desorption of the hydrogen fluoride can be performed in a short time, and therefore energy cost is low.

The temperature rise rate when the temperature is raised to the heating temperature in the desorption step is not particularly limited. It is preferable to raise the temperature such that the desorption rate (or vaporization rate of the hydrogen fluoride) at which the hydrogen fluoride adsorbed on the sodium fluoride becomes gaseous hydrogen fluoride to be desorbed from the sodium fluoride is 10 mg/min or less per gram of the sodium fluoride adsorbing the hydrogen fluoride, and it is more preferable to raise the temperature such that the rate is 3 mg/min or less.

The extent to which the hydrogen fluoride is removed from the sodium fluoride is not particularly limited in the desorption step. It is preferable to perform the desorption step until the proportion of the hydrogen fluoride in the sodium fluoride is 0.1% by mass or less, more preferably to perform the desorption step until the proportion is 0.01% by mass or less, and still more preferably to perform the desorption step until the proportion is 0.001% by mass or less. However, it is most preferable to perform the desorption of the hydrogen fluoride until no hydrogen fluoride is desorbed from the sodium fluoride.

The time when the desorption of the hydrogen fluoride is finished can be detected as follows. More specifically, the outlet gas discharged from the sodium fluoride packed column is analyzed by a Fourier transform infrared spectroscopy. Then, when the peak at 4038 cm⁻¹, which is the absorption wavelength of the hydrogen fluoride, cannot be detected, the desorption step is finished.

When the hydrogen fluoride concentration in the outlet gas discharged from the sodium fluoride packed column reached a predetermined amount or less, the heating of the sodium fluoride packed column is controlled to lower the temperature of the sodium fluoride to the adsorption temperature. The sodium fluoride lowered to the adsorption temperature can be reused as an adsorbent of hydrogen fluoride.

In the desorption step, the space velocity of the heat treatment atmospheric gas supplied to the sodium fluoride packed column is not particularly limited, and is preferably 200 (/h) or more and 1000 (/h) or less and more preferably 500 (/h) or more and 900 (/h) or less. When the SV is 200 (/h) or more and 1000 (/h) or less, the desorption step can be completed in a short time and the used amount of the heat treatment atmospheric gas is small, which is economical.

The pressure in the desorption step is not particularly limited, and the desorption step is preferably carried out at a pressure around the atmospheric pressure. In the case of normal pressure, the SV of the heat treatment atmospheric gas supplied to the sodium fluoride packed column is likely to be an optimal value.

According to the method for removing hydrogen fluoride of this embodiment, even when the gas to be treated has a high hydrogen fluoride concentration, hydrogen fluoride can be removed from the gas to be treated until the hydrogen fluoride concentration becomes a low concentration using sodium fluoride. Further, the method for removing hydrogen fluoride according to this embodiment makes it possible to efficiently, stably, and continuously remove hydrogen fluoride from the gas to be treated.

The use of the method for removing hydrogen fluoride according to this embodiment enables the removal of hydrogen fluoride, which is an impurity, from the gas of the fluorine-containing compound, and therefore high-purity fluorine-containing compounds useful as gases for use in the manufacture of semiconductors can be obtained.

### EXAMPLES

Hereinafter, the present disclosure will be more specifically described with reference to Examples and Comparative Examples below.

### Example 1

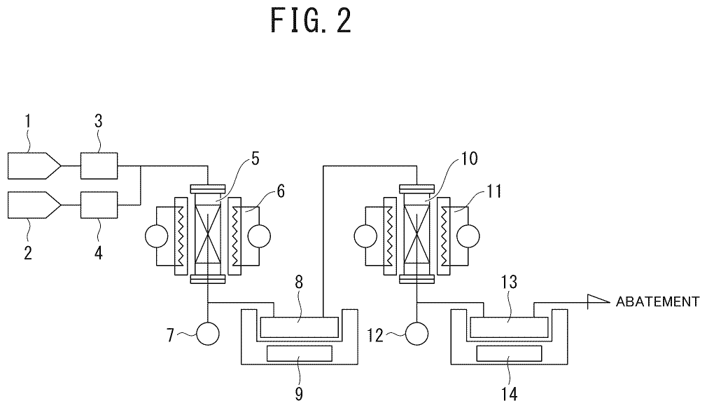

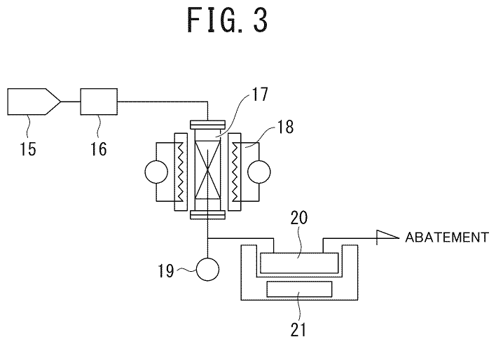

Using a hydrogen fluoride removal device illustrated in FIG. 2 and a desorption device illustrated in FIG. 3, a test of removing hydrogen fluoride from gas to be treated containing the hydrogen fluoride was carried out. First, the hydrogen fluoride removal device illustrated in FIG. 2 and the desorption device illustrated in FIG. 3 will be described.

The hydrogen fluoride removal device illustrated in FIG. 2 is a device carrying out the first adsorption step and the second adsorption step. The desorption device illustrated in FIG. 3 is a device carrying out the desorption step. In detail, the hydrogen fluoride removal device includes: a hydrogen fluoride gas supply section 1 supplying hydrogen fluoride gas; a dilution gas supply section 2 supplying fluorine gas, which is dilution gas diluting the hydrogen fluoride gas; a hydrogen fluoride gas flow-rate control device 3 controlling the flow rate of the hydrogen fluoride gas; a dilution gas flow-rate control device 4 controlling the flow rate of the dilution gas; a cylindrical sodium fluoride packed column 5 packed with sodium fluoride granular materials (not illustrated); a temperature control section 6 controlling the temperature of the sodium fluoride granular materials in the sodium fluoride packed column 5; a temperature measurement section 7 measuring the temperature of the sodium fluoride granular materials in the sodium fluoride packed column 5; an analysis section 8 holding outlet gas to analyze the outlet gas passing through the sodium fluoride packed column 5 and discharged from a discharge port of the sodium fluoride packed column 5; a Fourier transform infrared spectroscopy 9 performing infrared spectroscopic analysis of the outlet gas in the analysis section 8; a cylindrical sodium fluoride packed column 10 packed with sodium fluoride granular materials (not illustrated) for adsorbing hydrogen fluoride in the outlet gas passing through the analysis section 8 and discharged from the discharge port of the analysis section 8; a temperature control section 11 controlling the temperature of the sodium fluoride granular materials in the sodium fluoride packed column 10; a temperature measurement section 12 measuring the temperature of the sodium fluoride granular materials in the sodium fluoride packed column 10; an analysis section 13 holding the outlet gas to analyze the outlet gas passing through the sodium fluoride packed column 10 and discharged from the discharge port of the sodium fluoride packed column 10; and a Fourier transform infrared spectroscopy 14 performing the infrared spectroscopic analysis of the outlet gas in the analysis section 13.

The above-described sections possessed by the hydrogen fluoride removal device are connected to each other by piping as illustrated in FIG. 2. The hydrogen fluoride gas sent from the hydrogen fluoride gas supply section 1 and the fluorine gas sent from the dilution gas supply section 2 are mixed in the piping after the flow rates are controlled by the hydrogen fluoride gas flow-rate control device 3 and the dilution gas flow-rate control device 4, respectively.

The hydrogen fluoride-containing gas (gas to be treated) which is mixed gas of the hydrogen fluoride gas and the fluorine gas is sent to the sodium fluoride packed column 5 through the piping, and comes into contact with the sodium fluoride granular materials, so that the hydrogen fluoride in the hydrogen fluoride-containing gas is adsorbed on the sodium fluoride granular materials. At this time, the temperature of the sodium fluoride granular materials in the sodium fluoride packed column 5 is measured by the temperature measurement section 7 and controlled by the temperature control section 6.

The outlet gas coming out of the sodium fluoride packed column 5 is sent to the analysis section 8 through the piping, the infrared spectroscopic analysis is performed by the Fourier transform infrared spectroscopy 9, and the hydrogen fluoride concentration is measured.

The outlet gas coming out of the analysis section 8 is sent to the sodium fluoride packed column 10 through the piping, and comes into contact with the sodium fluoride granular materials, so that the hydrogen fluoride in the outlet gas of the sodium fluoride packed column 5 is adsorbed on the sodium fluoride granular materials. At this time, the temperature of the sodium fluoride granular materials in the sodium fluoride packed column 10 is measured by the temperature measurement section 12 and controlled by the temperature control section 11.

The outlet gas coming out of the sodium fluoride packed column 10 is sent to the analysis section 13 through the piping, the infrared spectroscopic analysis is performed by the Fourier transform infrared spectroscopy 14, and the hydrogen fluoride concentration is measured. Then, the outlet gas subjected to the infrared spectroscopic analysis is discharged from the analysis section 13 to the outside of the hydrogen fluoride removal device through the piping.

The desorption device includes: a heat treatment atmospheric gas supply section 15 supplying nitrogen gas which is the heat treatment atmospheric gas; a heat treatment atmospheric gas flow-rate control device 16 controlling the flow rate of the heat treatment atmospheric gas; a cylindrical sodium fluoride packed column 17 packed with the sodium fluoride granular materials (not illustrated) subjected to the fluoride first adsorption step or the second adsorption step and adsorbing hydrogen fluoride; a temperature control section 18 controlling the temperature of the sodium fluoride granular materials in the sodium fluoride packed column 17; a temperature measurement section 19 measuring the temperature of the sodium fluoride granular materials in the sodium fluoride packed column 17; an analysis section 20 holding the outlet gas to analyze the outlet gas passing through the sodium fluoride packed column 17 and discharged from the discharge port of the sodium fluoride packed column 17; and a Fourier transform infrared spectroscopy 21 performing infrared spectroscopic analysis of the outlet gas in the analysis section 20.

The above-described sections possessed by the desorption device are connected to each other by piping as illustrated in FIG. 3. The heat treatment atmospheric gas sent from the heat treatment atmospheric gas supply section 15 is sent to the sodium fluoride packed column 17 through the piping, and the sodium fluoride granular materials in the sodium fluoride packed column 17 are heated in the heat treatment atmospheric gas. At this time, the temperature of the sodium fluoride granular materials in the sodium fluoride packed column 17 is measured by the temperature measurement section 19 and controlled by the temperature control section 18.

The outlet gas coming out of the sodium fluoride packed column 17 is sent to the analysis section 20 through the piping, the infrared spectroscopic analysis is performed by the Fourier transform infrared spectroscopy 21, and the hydrogen fluoride concentration is measured. Then, the outlet gas subjected to the infrared spectroscopic analysis is discharged from the analysis section 20 to the outside of the desorption device through the piping.

Next, the sodium fluoride granular materials will be described. The sodium fluoride granular materials are sodium fluoride pellets manufactured by Morita Chemical Co., Ltd., and have a cylindrical columnar shape with a diameter of 3 mm and a height of 3 mm. One sodium fluoride pellet has an apparent density of 2.1 g/mL and a packed bulk density of 1.3 g/mL. The specific surface area of the sodium fluoride pellets was 0.175 m²/g as measured by mercury intrusion porosimetry. The average pore size of pores formed on the surfaces of the sodium fluoride pellets was 1.73 μm as measured by mercury intrusion porosimetry.

Next, the sodium fluoride packed column 5, the sodium fluoride packed column 10, and the sodium fluoride packed column 17 packed with the sodium fluoride pellets will be described. The sodium fluoride packed column 5 used in the first adsorption step, the sodium fluoride packed column 10 used in the second adsorption step, and the sodium fluoride packed column 17 used in the desorption step are all nickel cylindrical members with an inner diameter of 38 mm, an outer diameter of 40 mm, and a length of 300 mm. The sodium fluoride packed column 5, the sodium fluoride packed column 10, and the sodium fluoride packed column 17 are placed such that the longitudinal directions of the cylindrical members are along the vertical direction.

The inside of each of the sodium fluoride packed column 5, the sodium fluoride packed column 10, and the sodium fluoride packed column 17 is packed with 44.2 g (capacity of 34 mL) of the sodium fluoride pellets. A nickel mesh is placed on a lower part of the cylindrical member, and the sodium fluoride pellets are placed on the nickel mesh, so that the sodium fluoride pellets are prevented from falling from the cylindrical member.

Next, treatment of allowing the hydrogen fluoride in the hydrogen fluoride-containing gas to adsorb on the sodium fluoride pellets (first adsorption step and second adsorption step) was carried out using the hydrogen fluoride removal device illustrated in FIG. 2. The temperature of the sodium fluoride pellets inside the sodium fluoride packed column 5 was adjusted to 60° C. by the temperature control section 6. The temperature of the sodium fluoride pellets inside the sodium fluoride packed column 10 was adjusted to 20° C. by the temperature control section 11.

Then, the hydrogen fluoride gas having a flow rate adjusted by the hydrogen fluoride gas flow-rate control device 3 and the fluorine gas having a flow rate adjusted by the dilution gas flow-rate control device 4 were mixed to produce the hydrogen fluoride-containing gas, and this hydrogen fluoride-containing gas was supplied to the sodium fluoride packed column 5 through the piping.

The hydrogen fluoride concentration of the hydrogen fluoride-containing gas supplied to the sodium fluoride packed column 5 is 10% by volume, and the SV of the hydrogen fluoride-containing gas is 265/h. The ratio of the mass of the hydrogen fluoride per unit time in the hydrogen fluoride-containing gas (gas to be treated) introduced into the sodium fluoride packed column 5 to the mass of the sodium fluoride granular materials before the adsorption is 18.2 HF-mg/NaF-g/h.

The entire amount of the outlet gas of the sodium fluoride packed column 5 was sent to the analysis section 8 and analyzed by the Fourier transform infrared spectroscopy 9, and the transition of the hydrogen fluoride concentration was traced. Then, a peak originating from the hydrogen fluoride (absorption wavelength of 4038 cm⁻¹) was detected a few minutes after the start of the supply of the hydrogen fluoride-containing gas.

Subsequently, the supply of the hydrogen fluoride-containing gas to the sodium fluoride packed column 5 was continued. Then, when the ratio of the mass of the hydrogen fluoride in the hydrogen fluoride-containing gas introduced into the sodium fluoride packed column 5 to the mass of the sodium fluoride granular materials before the adsorption reached 58.34 HF-mg/NaF-g, the supply of the hydrogen fluoride-containing gas was stopped. As the transition of the hydrogen fluoride concentration in the outlet gas of the sodium fluoride packed column 5 during the period from the supply of the hydrogen fluoride-containing gas to the sodium fluoride packed column 5 to the stop of the supply, the concentration increased to 270 ppm by volume after the detection of the hydrogen fluoride, and thereafter the almost constant concentration was exhibited.

The outlet gas coming out of the analysis section 8 is supplied to the sodium fluoride packed column 10 through the piping. The hydrogen fluoride concentration of the outlet gas of the sodium fluoride packed column 5 supplied to the sodium fluoride packed column 10 is 270 ppm by volume, and the SV of the outlet gas of the sodium fluoride packed column 5 is 238/h. The ratio of the mass of the hydrogen fluoride per unit time in the outlet gas of the sodium fluoride packed column 5 introduced into the sodium fluoride packed column 10 to the mass of the sodium fluoride granular materials before the adsorption is 0.04 HF-mg/NaF-g/h.

The supply of the outlet gas of the sodium fluoride packed column 5 from the analysis section 8 to the sodium fluoride packed column 10 was stopped when the ratio of the mass of the hydrogen fluoride in the outlet gas of the sodium fluoride packed column 5 introduced into the sodium fluoride packed column 10 to the mass of the sodium fluoride granular materials before the adsorption reached 0.14 HF-mg/NaF-g.

The entire amount of the outlet gas of the sodium fluoride packed column 10 was sent to the analysis section 13 to be analyzed by the Fourier transform infrared spectroscopy 14, and the transition of the hydrogen fluoride concentration was traced. Then, the peak (absorption wavelength of 4038 cm⁻¹) originating from the hydrogen fluoride was not detected from the start to the stop of the supply of the outlet gas of the sodium fluoride packed column 5, and the hydrogen fluoride concentration in the outlet gas of the sodium fluoride packed column 10 was 0.1 ppm by volume, which was the detection lower limit value, or less.

The hydrogen fluoride in the hydrogen fluoride-containing gas was removed using the hydrogen fluoride removal device as described above to obtain fluorine gas in Example 1. The hydrogen fluoride concentration in the fluorine gas obtained in Example 1 was 0.1 ppm by volume or less, and was approximately 1/2700 or less of the hydrogen fluoride concentration in fluorine gas obtained in Comparative Example 1 described later.

The inside of each of the sodium fluoride packed column 5 and the sodium fluoride packed column 10 was sufficiently replaced with nitrogen gas, and then the sodium fluoride pellets were taken out from the sodium fluoride packed column 5 and the sodium fluoride packed column 10 and visually observed. As a result, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred. Table 1 shows conditions of the first adsorption step and the second adsorption step. Table 2 shows the results.

TABLE 1

| | First adsorption step | | | | Second adsorption step | | |
|---|---|---|---|---|---|---|---|
| | | Mass ratio | Mass ratio | | | Mass ratio | Mass ratio |
| | | between NaF | between NaF and | Dilution | | between NaF | between NaF and |
| | Temperature | and HF | HF per unit time | gas | Temperature | and HF | HF per unit time |
| | ° C. | HF-mg/NaF-g | HF-mg/NaF-g/h | — | ° C. | HF-mg/NaF-g | HF-mg/NaF-g/h |
| Ex. 1 | 60 | 58.34 | 18.2 | F₂ | 20 | 0.14 | 0.04 |
| Ex. 2 | 60 | 15.27 | 18.2 | F₂ | 20 | 0.04 | 0.04 |
| Ex. 3 | 60 | 58.34 | 18.2 | F₂ | 40 | 0.14 | 0.04 |
| Ex. 4 | 60 | 65.12 | 1.2 | F₂ | 20 | 0.16 | 0.003 |
| Ex. 5 | 100 | 48.61 | 18.2 | F₂ | 20 | 1.49 | 0.57 |
| Ex. 6 | 60 | 61.89 | 9.1 | F₂ | −5 | 0.32 | 0.05 |
| Ex. 7 | 60 | 50.48 | 60.6 | F₂ | 20 | 0.06 | 0.07 |
| Ex. 8 | 115 | 44.18 | 33.9 | F₂ | 20 | 4.68 | 4.02 |
| Ex. 9 | 60 | 58.34 | 18.2 | F₂ | 20 | 0.14 | 0.04 |
| Ex. 10 | 60 | 58.34 | 18.2 | F₂ | 20 | 0.14 | 0.04 |
| Ex. 11 | 60 | 58.34 | 18.2 | F₂ | 20 | 0.14 | 0.04 |
| Ex. 12 | 60 | 58.34 | 18.2 | F₂ | 20 | 0.14 | 0.04 |
| Ex. 13 | 100 | 48.61 | 18.2 | F₂ | 20 | 89.37 | 0.57 |
| Ex. 14 | 60 | 58.34 | 18.2 | ClF₃ | 20 | 0.14 | 0.04 |
| Ex. 15 | 60 | 58.34 | 18.2 | F₂ | 20 | 0.14 | 0.04 |
| Comp. Ex. 1 | 60 | 58.20 | 18.2 | F₂ | — | — | — |
| Comp. Ex. 2 | 80 | 53.74 | 18.2 | F₂ | — | — | — |
| Comp. Ex. 3 | 100 | 52.63 | 18.2 | F₂ | — | — | — |
| Comp. Ex. 4 | 60 | 58.97 | 0.03 | F₂ | 20 | 0.77 | 0.0004 |
| Comp. Ex. 5 | 60 | 58.25 | 90.9 | F₂ | 20 | 0.05 | 0.07 |

| | | | | | | Number of | Number of |
|---|---|---|---|---|---|---|---|
| | | | | | | times of | times of |
| | | Desorption step | | | | repeatedly | repeatedly |
| | | NaF packed column 5 | | NaF packed column 10 | | performing | performing |
| | | | Flow rate of | | Flow rate of | first | second |
| | | | heat | | heat | adsorption | adsorption |
| | Second adsorption step | | treatment | | treatment | step and | step and |
| | Dilution | | atmospheric | | atmospheric | desorption | desorption |
| | gas | Temperature | gas | Temperature | gas | step | step |
| | — | ° C. | NmL/min | ° C. | NmL/min | times | times |
| Ex. 1 | F₂ | — | — | — | — | — | — |
| Ex. 2 | F₂ | — | — | — | — | — | — |
| Ex. 3 | F₂ | — | — | — | — | — | — |
| Ex. 4 | F₂ | — | — | — | — | — | — |
| Ex. 5 | F₂ | — | — | — | — | — | — |
| Ex. 6 | F₂ | — | — | — | — | — | — |
| Ex. 7 | F₂ | — | — | — | — | — | — |
| Ex. 8 | F₂ | — | — | — | — | — | — |
| Ex. 9 | F₂ | 200 | 450 | 200 | 450 | 1 | 1 |
| Ex. 10 | F₂ | 150 | 450 | 150 | 450 | 1 | 1 |
| Ex. 11 | F₂ | 230 | 450 | 230 | 450 | 1 | 1 |
| Ex. 12 | F₂ | 200 | 450 | 200 | 450 | 40 | 40 |
| Ex. 13 | F₂ | 200 | 450 | — | — | 60 | — |
| Ex. 14 | ClF₃ | — | — | — | — | — | — |
| Ex. 15 | F₂ | 250 | 1000 | 250 | 450 | 40 | 40 |
| Comp. Ex. 1 | F₂ | — | — | — | — | — | — |
| Comp. Ex. 2 | F₂ | — | — | — | — | — | — |
| Comp. Ex. 3 | F₂ | — | — | — | — | — | — |
| Comp. Ex. 4 | F₂ | — | — | — | — | — | — |
| Comp. Ex. 5 | F₂ | — | — | — | — | — | — |

TABLE 2

| | Adsorption step | | | | | |
|---|---|---|---|---|---|---|
| | First adsorption step | | | Second adsorption step | | |
| | Occurrence or | Occurrence or | Occurrence or | Occurrence or | Occurrence or | Occurrence or |
| | non-occurrence | non-occurrence | non-occurrence | non-occurrence | non-occurrence | non-occurrence |
| | of powdering | of cracking | of joining | of powdering | of cracking | of joining |
| | — | — | — | — | — | — |
| Ex. 1 | Non-occurrence | Non-occurrence | Non-occurrence | Non-occurrence | Non-occurrence | Non-occurrence |
| Ex. 2 | Non-occurrence | Non-occurrence | Non-occurrence | Non-occurrence | Non-occurrence | Non-occurrence |
| Ex. 3 | Non-occurrence | Non-occurrence | Non-occurrence | Non-occurrence | Non-occurrence | Non-occurrence |
| Ex. 4 | Non-occurrence | Non-occurrence | Non-occurrence | Non-occurrence | Non-occurrence | Non-occurrence |
| Ex. 5 | Non-occurrence | Non-occurrence | Non-occurrence | Non-occurrence | Non-occurrence | Non-occurrence |
| Ex. 6 | Non-occurrence | Non-occurrence | Non-occurrence | Non-occurrence | Non-occurrence | Non-occurrence |
| Ex. 7 | Non-occurrence | Non-occurrence | Non-occurrence | Non-occurrence | Non-occurrence | Non-occurrence |
| Ex. 8 | Non-occurrence | Non-occurrence | Non-occurrence | Non-occurrence | Non-occurrence | Non-occurrence |
| Ex. 9 | Non-occurrence | Non-occurrence | Non-occurrence | Non-occurrence | Non-occurrence | Non-occurrence |
| Ex. 10 | Occurrence | Occurrence | Occurrence | Non-occurrence | Non-occurrence | Non-occurrence |
| Ex. 11 | Occurrence | Occurrence | Occurrence | Non-occurrence | Non-occurrence | Non-occurrence |
| Ex. 12 | Occurrence | Occurrence | Occurrence | Non-occurrence | Non-occurrence | Non-occurrence |
| Ex. 13 | Occurrence | Occurrence | Occurrence | Non-occurrence | Non-occurrence | Non-occurrence |
| Ex. 14 | Non-occurrence | Non-occurrence | Non-occurrence | Non-occurrence | Non-occurrence | Non-occurrence |
| Ex. 15 | Occurrence | Occurrence | Occurrence | Occurrence | Occurrence | Occurrence |
| Comp. Ex. 1 | Non-occurrence | Non-occurrence | Non-occurrence | — | — | — |
| Comp. Ex. 2 | Non-occurrence | Non-occurrence | Non-occurrence | — | — | — |
| Comp. Ex. 3 | Non-occurrence | Non-occurrence | Non-occurrence | — | — | — |
| Comp. Ex. 4 | Occurrence | Non-occurrence | Occurrence | Non-occurrence | Non-occurrence | Non-occurrence |
| Comp. Ex. 5 | Non-occurrence | Non-occurrence | Occurrence | Non-occurrence | Non-occurrence | Non-occurrence |

| Adsorption step | Desorption step | |
|---|---|---|
| HF concentration | | |
| in outlet gas of | NaF packed column 5 | NaF packed column 10 |

| | NaF packed | HF concentration | Desorption rate of | HF concentration | Desorption rate of |
|---|---|---|---|---|---|
| | column 10 | in outlet gas | hydrogen fluoride | in outlet gas | hydrogen fluoride |
| | ppm by volume | % by volume | HF-mg/min/NaF-g | % by volume | HF-mg/min/NaF-g |
| Ex. 1 | Less than 0.1 | — | — | — | — |
| Ex. 2 | Less than 0.1 | — | — | — | — |
| Ex. 3 | Less than 0.1 | — | — | — | — |
| Ex. 4 | Less than 0.1 | — | — | — | — |
| Ex. 5 | Less than 0.1 | — | — | — | — |
| Ex. 6 | Less than 0.1 | — | — | — | — |
| Ex. 7 | Less than 0.1 | — | — | — | — |
| Ex. 8 | Less than 0.1 | — | — | — | — |
| Ex. 9 | Less than 0.1 | 8.7 | 0.79 | 8.7 | 0.79 |
| Ex. 10 | Less than 0.1 | 1.3 | 0.12 | 1.3 | 0.12 |
| Ex. 11 | Less than 0.1 | 27 | 2.45 | 27 | 2.45 |
| Ex. 12 | Less than 0.1 | 8.7 | 0.79 | 8.7 | 0.79 |
| Ex. 13 | Less than 0.1 | 8.7 | 0.79 | — | — |
| Ex. 14 | Less than 0.1 | — | — | — | — |
| Ex. 15 | Less than 0.1 | 66.44 | 13.42 | 8.7 | 0.79 |
| Comp. Ex. 1 | 270 | — | — | — | — |
| Comp. Ex. 2 | 1500 | — | — | — | — |
| Comp. Ex. 3 | 3500 | — | — | — | — |
| Comp. Ex. 4 | Less than 0.1 | — | — | — | — |
| Comp. Ex. 5 | Less than 0.1 | — | — | — | — |

### Example 2

Hydrogen fluoride was removed in exactly the same manner as in Example 1, except that, in the first adsorption step, the ratio of the mass of the hydrogen fluoride in the hydrogen fluoride-containing gas introduced into the sodium fluoride packed column 5 to the mass of the sodium fluoride granular materials before the adsorption was 15.27 HF-mg/NaF-g and, in the second adsorption step, the ratio of the mass of the hydrogen fluoride in the outlet gas of the sodium fluoride packed column 5 introduced into the sodium fluoride packed column 10 to the mass of the sodium fluoride granular materials before the adsorption was 0.04 HF-mg/NaF-g.

The hydrogen fluoride concentration in fluorine gas obtained in Example 2 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 3

Hydrogen fluoride was removed in exactly the same manner as in Example 1, except that the adsorption temperature of the second adsorption step was 40° C.

The hydrogen fluoride concentration in fluorine gas obtained in Example 3 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 4

Hydrogen fluoride was removed in exactly the same manner as in Example 1, except for the following differences in the first adsorption step and the second adsorption step.

More specifically, Example 4 is different from Example 1 in that, in the first adsorption step, the ratio of the mass of the hydrogen fluoride per unit time in the hydrogen fluoride-containing gas introduced into the sodium fluoride packed column 5 to the mass of the sodium fluoride granular materials before the adsorption is 1.2 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 65.12 HF-mg/NaF-g, and the SV of the hydrogen fluoride-containing gas is 17.6/h.

Further, Example 4 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.003 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 0.16 HF-mg/NaF-g, and the SV of the outlet gas of the sodium fluoride packed column 5 is 15.9/h.

The hydrogen fluoride concentration in fluorine gas obtained in Example 4 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 5

Hydrogen fluoride was removed in exactly the same manner as in Example 1, except for the following differences in the first adsorption step and the second adsorption step.

More specifically, Example 5 is different from Example 1 in that, in the first adsorption step, the adsorption temperature is 100° C. and the ratio of the mass of the hydrogen fluoride in the hydrogen fluoride-containing gas introduced into the sodium fluoride packed column 5 to the mass of the sodium fluoride granular materials before the adsorption is 48.6 HF-mg/NaF-g.

Further, Example 5 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.57 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 1.49 HF-mg/NaF-g, and the SV of the outlet gas of the sodium fluoride packed column 5 is 239/h.

The hydrogen fluoride concentration in fluorine gas obtained in Example 5 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 6

Hydrogen fluoride was removed in exactly the same manner as in Example 1, except for the following differences in the first adsorption step and the second adsorption step.

More specifically, Example 6 is different from Example 1 in that, in the first adsorption step, the ratio of the mass of the hydrogen fluoride per unit time in the hydrogen fluoride-containing gas introduced into the sodium fluoride packed column 5 to the mass of the sodium fluoride granular materials before the adsorption is 9.1 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 61.89 HF-mg/NaF-g, and the hydrogen fluoride concentration of the hydrogen fluoride-containing gas supplied to the sodium fluoride packed column 5 is 5% by volume.

Further, Example 6 is different from Example 1 in that, in the second adsorption step, the adsorption temperature is −5° C., the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.05 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 0.32 HF-mg/NaF-g, and the SV of the outlet gas of the sodium fluoride packed column 5 is 252/h.

The hydrogen fluoride concentration in fluorine gas obtained in Example 6 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 7

Hydrogen fluoride was removed in exactly the same manner as in Example 1, except for the following differences in the first adsorption step and the second adsorption step.

More specifically, Example 7 is different from Example 1 in that, in the first adsorption step, the ratio of the mass of the hydrogen fluoride per unit time in the hydrogen fluoride-containing gas introduced into the sodium fluoride packed column 5 to the mass of the sodium fluoride granular materials before the adsorption is 60.6 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 50.48 HF-mg/NaF-g, and the SV of the hydrogen fluoride-containing gas supplied to the sodium fluoride packed column 5 is 490/h.

Further, Example 7 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.07 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 0.06 HF-mg/NaF-g, and the SV of the outlet gas of the sodium fluoride packed column 5 is 402/h.

The hydrogen fluoride concentration in fluorine gas obtained in Example 7 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 8

Hydrogen fluoride was removed in exactly the same manner as in Example 1, except for the following differences in the first adsorption step and the second adsorption step.

More specifically, Example 8 is different from Example 1 in that the adsorption temperature is 115° C., the ratio of the mass of the hydrogen fluoride per unit time in the hydrogen fluoride-containing gas introduced into the sodium fluoride packed column 5 to the mass of the sodium fluoride granular materials before the adsorption is 33.9 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 44.18 HF-mg/NaF-g, and the SV of the hydrogen fluoride-containing gas supplied to the sodium fluoride packed column 5 is 494/h.

Further, Example 8 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 4.02 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 4.68 HF-mg/NaF-g, the hydrogen fluoride concentration of the outlet gas of the sodium fluoride packed column 5 is 13000 ppm by volume, and the SV of the outlet gas of the sodium fluoride packed column 5 is 451/h.

The hydrogen fluoride concentration in fluorine gas obtained in Example 8 was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 9

The first adsorption step and the second adsorption step were performed in exactly the same manner as in Example 1 to remove the hydrogen fluoride from the hydrogen fluoride-containing gas, and the desorption step was performed to desorb the hydrogen fluoride from the sodium fluoride pellets. More specifically, the desorption step was performed by heating the sodium fluoride pellets of the sodium fluoride packed column 5 and the sodium fluoride packed column 10 in the temperature control section 18 while the heat treatment atmospheric gas was being supplied from the heat treatment atmospheric gas supply section 15 to the sodium fluoride packed column 5 and the sodium fluoride packed column 10 after the first adsorption step and the second adsorption step, respectively, had been finished. The heat treatment atmospheric gas is nitrogen gas. The flow rate was adjusted to 450 NmL/min by the heat treatment atmospheric gas flow-rate control device 16. The temperature (desorption temperature) of the sodium fluoride pellets in the desorption step was set to 200° C. Table 1 shows the conditions of the desorption step. Table 2 shows the results.

The desorption step may also be performed by transferring the sodium fluoride pellets from the sodium fluoride packed column 5 and the sodium fluoride packed column 10 after the first adsorption step and the second adsorption step, respectively, had been finished to another sodium fluoride packed column 17 (sodium fluoride packed column 17 for the desorption step). Therefore, in FIG. 3, the reference sign of the sodium fluoride packed column for the desorption step is 17 for convenience of description, but, in Example 9, the desorption step was performed using the sodium fluoride packed column 5 and the sodium fluoride packed column 10 for the first adsorption step and the second adsorption step, respectively, as they are as the sodium fluoride packed column 17 for the desorption step.

As in the case of the sodium fluoride packed column 17, the desorption step was performed using the temperature control sections 6, 11, the temperature measurement sections 7, 12, the analysis sections 8, 13, and the Fourier transform infrared spectroscopies 9, 14 used in the first adsorption step and the second adsorption step, respectively, as they are in Example 9 also for the temperature control section 18, the temperature measurement section 19, the analysis section 20, and the Fourier transform infrared spectroscopy 21 in FIG. 3.

During the desorption step, the outlet gas of the sodium fluoride packed column 5 was sent to the analysis section 8 for analysis by the Fourier transform infrared spectroscopy 9, and the hydrogen fluoride concentration was measured to be 8.7% by volume at maximum. The flow rate of the heat treatment atmospheric gas is 450 NmL/min, and therefore the hydrogen fluoride was desorbed at a rate of approximately 39 NmL/min, and was desorbed at a rate of 35 mg/min in terms of mass.

The mass of the sodium fluoride pellets is 44.2 g, and therefore the desorption rate of the hydrogen fluoride is 0.79 mg/min per gram of the sodium fluoride pellets. Also in the sodium fluoride packed column 10, the hydrogen fluoride was desorbed under the same conditions as those of the sodium fluoride packed column 5. The first adsorption step, the second adsorption step, and the desorption step each were carried out once as described above, the temperature of the sodium fluoride pellets was set to the adsorption temperature, and the hydrogen fluoride adsorption operations, which were exactly the same as those of the first adsorption step and the second adsorption step, were performed again to obtain fluorine gas.

The hydrogen fluoride concentration in the fluorine gas thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 10

The first adsorption step, the second adsorption step, and the desorption step each were carried out once in exactly the same manner as in Example 9, except that the desorption temperatures in the sodium fluoride packed column 5 and the sodium fluoride packed column 10 were 150° C. in the desorption step, and then the hydrogen fluoride adsorption operation was performed again in exactly the same manner as in Example 9.

The hydrogen fluoride concentration in fluorine gas thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, powdering, cracking, and joining of the pellets occurred in the sodium fluoride pellets of the sodium fluoride packed column 5. In detail, for the sodium fluoride pellets arranged in a portion close to an introduction port of the hydrogen fluoride-containing gas of the inside of the sodium fluoride packed column 5 (range of approximately ⅓ of the central axis length of the sodium fluoride packed column 5), powdering and cracking of the sodium fluoride and joining of the pellets occurred. For a portion other than the portion close to the introduction port described above of the sodium fluoride packed column 5, no joining of the sodium fluoride pellets occurred.

For the sodium fluoride pellets of the sodium fluoride packed column 10, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 11

The first adsorption step, the second adsorption step, and the desorption step each were carried out once in exactly the same manner as in Example 9, except that the desorption temperatures in the sodium fluoride packed column 5 and the sodium fluoride packed column 10 were 230° C. in the desorption step, and then the hydrogen fluoride adsorption operation was performed again in exactly the same manner as in Example 9.

The hydrogen fluoride concentration in fluorine gas thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, powdering, cracking, and joining of the pellets occurred in the sodium fluoride pellets of the sodium fluoride packed column 5. In detail, for the sodium fluoride pellets arranged in a portion close to the introduction port of the hydrogen fluoride-containing gas of the inside of the sodium fluoride packed column 5 (range of approximately ⅓ of the central axis length of the sodium fluoride packed column 5), powdering and cracking of the sodium fluoride and joining of the pellets occurred. For a portion other than the portion close to the introduction port described above of the sodium fluoride packed column 5, no joining of the sodium fluoride pellets occurred.

For the sodium fluoride pellets of the sodium fluoride packed column 10, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 12

In Example 9, the fluorine gas was obtained by performing each of the first adsorption step, the second adsorption step, and the desorption step once, and then performing the hydrogen fluoride adsorption operation again. However, in Example 12, performing each of the first adsorption step, the second adsorption step, and the desorption step once was set as one cycle, and the cycle was repeatedly performed for 40 cycles. Thereafter, the hydrogen fluoride adsorption operation was performed again to obtain fluorine gas. Example 12 is exactly the same as Example 9, except for repeating the cycle for 40 cycles.

The hydrogen fluoride concentration in fluorine gas thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, powdering, cracking, and joining of the pellets occurred in the sodium fluoride pellets of the sodium fluoride packed column 5. In detail, for the sodium fluoride pellets arranged in a portion close to the introduction port of the hydrogen fluoride-containing gas of the inside of the sodium fluoride packed column 5 (range of approximately ⅓ of the central axis length of the sodium fluoride packed column 5), powdering and cracking of the sodium fluoride and joining of the pellets occurred. For a portion other than the portion close to the introduction port described above of the sodium fluoride packed column 5, no joining of the sodium fluoride pellets occurred.

For the sodium fluoride pellets of the sodium fluoride packed column 10, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 13

The first adsorption step, the second adsorption step, and the desorption step were carried out in exactly the same manner as in Example 5, and then the hydrogen fluoride adsorption operation was performed again in exactly the same manner as in Example 9, except that the specific surface area of the sodium fluoride pellets to be used was 1.5 m²/g, the same desorption step as that of Example 9 was carried out only for the sodium fluoride pellets of the sodium fluoride packed column 5 and the desorption step was not carried out for the sodium fluoride pellets of the sodium fluoride packed column 10, the number of times the first adsorption step and the desorption step were repeatedly performed for the sodium fluoride pellets of the sodium fluoride packed column 5 was set to 60, and the ratio of the mass of the hydrogen fluoride in the outlet gas of the sodium fluoride packed column 5 introduced into the sodium fluoride packed column 10 to the mass of the sodium fluoride granular materials before the adsorption was 89.37 HF-mg/NaF-g in the second adsorption step.

The hydrogen fluoride concentration in fluorine gas thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, powdering, cracking, and joining of the pellets occurred in the sodium fluoride pellets of the sodium fluoride packed column 5. In detail, for the sodium fluoride pellets arranged in a portion close to the introduction port of the hydrogen fluoride-containing gas of the inside of the sodium fluoride packed column 5 (range of approximately ⅓ of the central axis length of the sodium fluoride packed column 5), powdering and cracking of the sodium fluoride and joining of the pellets occurred. For a portion other than the portion close to the introduction port described above of the sodium fluoride packed column 5, no joining of the sodium fluoride pellets occurred.

For the sodium fluoride pellets of the sodium fluoride packed column 10, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 14

Hydrogen fluoride was removed in exactly the same manner as in Example 1, except that the dilution gas diluting the hydrogen fluoride gas was changed to chlorine trifluoride in place of the fluorine gas.

The hydrogen fluoride concentration in the chlorine trifluoride thus obtained was 0.1 ppm by volume or less, and was approximately 1/2700 or less of the hydrogen fluoride concentration in the fluorine gas obtained in Comparative Example 1 described later.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Example 15

The first adsorption step, the second adsorption step, and the desorption step each were carried out 40 times in exactly the same manner as in Example 12, except that the desorption temperatures in the sodium fluoride packed column 5 and the sodium fluoride packed column 10 were 250° C. in the desorption step and the flow rate of the heat treatment atmospheric gas to the sodium fluoride packed column 5 was 1000 NmL/min, and then the hydrogen fluoride adsorption operation was performed again in exactly the same manner as in Example 9.

The hydrogen fluoride concentration in fluorine gas thus obtained was 0.1 ppm by volume or less, and was approximately 1/2700 or less of the hydrogen fluoride concentration in the fluorine gas obtained in Comparative Example 1 described later.

However, from the time when the number of times the first adsorption step, the second adsorption step, and the desorption step were repeatedly performed reached 30, the pressure inside the sodium fluoride packed column 5 started to sharply increase and the outlet gas did not flow out of the sodium fluoride packed column 5.

When the sodium fluoride pellets were observed in the same manner as in Example 1, powdering and cracking occurred for the sodium fluoride pellets of the sodium fluoride packed column 5. It is considered that, when the desorption rate of the hydrogen fluoride is high, the hydrogen fluoride adsorbed on the pellet surfaces is rapidly vaporized, and therefore a phenomenon in which powdering or cracking occurs is likely to occur. As a result, it is considered that clogging occurred, so that a gas flow path was blocked.

### Comparative Example 1

Hydrogen fluoride was removed in exactly the same manner as in Example 1, except that the hydrogen fluoride was removed only by the first adsorption step without carrying out the second adsorption step. The hydrogen fluoride concentration in fluorine gas thus obtained was 270 ppm by volume.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Comparative Example 2

Hydrogen fluoride was removed in exactly the same manner as in Comparative Example 1, except that the adsorption temperature was 80° C. The hydrogen fluoride concentration in fluorine gas thus obtained was 1500 ppm by volume.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Comparative Example 3

Hydrogen fluoride was removed in exactly the same manner as in Comparative Example 1, except that the adsorption temperature was 100° C. The hydrogen fluoride concentration in fluorine gas thus obtained was 3500 ppm by volume.

When the sodium fluoride pellets were observed in the same manner as in Example 1, there was no change in the appearance of the sodium fluoride pellets as compared with that before the contact with the hydrogen fluoride gas. More specifically, no powdering of the sodium fluoride pellets, no cracking of the sodium fluoride pellets, and no joining of the sodium fluoride pellets occurred.

### Comparative Example 4

Hydrogen fluoride was removed in exactly the same manner as in Example 1, except for the following differences in the first adsorption step and the second adsorption step.

More specifically, Comparative Example 4 is different from Example 1 in that, in the first adsorption step, the ratio of the mass of the hydrogen fluoride per unit time in the hydrogen fluoride-containing gas introduced into the sodium fluoride packed column 5 to the mass of the sodium fluoride granular materials before the adsorption is 0.03 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 58.97 HF-mg/NaF-g, the hydrogen fluoride concentration of the hydrogen fluoride-containing gas supplied to the sodium fluoride packed column 5 is 2% by volume, and the SV of the hydrogen fluoride-containing gas supplied to the sodium fluoride packed column 5 is 2/h.

Further, Comparative Example 4 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.0004 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 0.77 HF-mg/NaF-g, and the SV of the outlet gas of the sodium fluoride packed column 5 is 2/h.

The hydrogen fluoride concentration in fluorine gas thus obtained was 0.1 ppm by volume or less, and was approximately 1/2700 or less of the hydrogen fluoride concentration in the fluorine gas obtained in Comparative Example 1.

However, from around the time when the adsorption amount of the hydrogen fluoride to the sodium fluoride pellets of the sodium fluoride packed column 5 reached 5.5% by mass of the mass of the sodium fluoride, the pressure inside the sodium fluoride packed column 5 started to sharply increase and the outlet gas did not flow out of the sodium fluoride packed column 5.

When the sodium fluoride pellets were observed in the same manner as in Example 1, powdering and joining of the pellets occurred in the sodium fluoride pellets of the sodium fluoride packed column 5. In detail, for the sodium fluoride pellets arranged in a portion close to the introduction port of the hydrogen fluoride-containing gas of the inside of the sodium fluoride packed column 5 (range of approximately ⅓ of the central axis length of the sodium fluoride packed column 5), powdering of the sodium fluoride and joining of the pellets occurred. For a portion other than the portion close to the introduction port described above of the sodium fluoride packed column 5, no joining of the sodium fluoride pellets occurred.

It is considered that, when the flow rate of the hydrogen fluoride-containing gas is low, the supply rate of the hydrogen fluoride also becomes low, and therefore the hydrogen fluoride is likely to be adsorbed on the sodium fluoride pellets arranged in a portion closest to the introduction port of the hydrogen fluoride-containing gas of the inside of the sodium fluoride packed column 5. As a result, it is considered that the sodium fluoride pellets arranged in the portion closest to the introduction port of the hydrogen fluoride-containing gas adsorbed a large amount of the hydrogen fluoride, and therefore powdering or joining occurred, and clogging occurred, so that a gas flow path was blocked.

### Comparative Example 5

Hydrogen fluoride was removed in exactly the same manner as in Example 1, except for the following differences in the first adsorption step and the second adsorption step.

More specifically, Comparative Example 5 is different from Example 1 in that, in the first adsorption step, the ratio of the mass of the hydrogen fluoride per unit time in the hydrogen fluoride-containing gas introduced into the sodium fluoride packed column 5 to the mass of the sodium fluoride granular materials before the adsorption is 90.9 HF-mg/NaF-g/h, the ratio of the mass of the hydrogen fluoride in the hydrogen fluoride-containing gas introduced into the sodium fluoride packed column 5 to the mass of the sodium fluoride granular materials before the adsorption is 58.25 HF-mg/NaF-g, the hydrogen fluoride concentration of the hydrogen fluoride-containing gas supplied to the sodium fluoride packed column 5 is 25% by volume, and the SV of the hydrogen fluoride-containing gas supplied to the sodium fluoride packed column 5 is 529/h.

Further, Comparative Example 5 is different from Example 1 in that, in the second adsorption step, the ratio of the mass of the hydrogen fluoride per unit time in the outlet gas of the sodium fluoride packed column 5 introduced into the sodium fluoride packed column 10 to the mass of the sodium fluoride granular materials before the adsorption is 0.07 HF-mg/NaF-g/h, the ratio of the mass of the hydrogen fluoride in the outlet gas of the sodium fluoride packed column 5 introduced into the sodium fluoride packed column 10 to the mass of the sodium fluoride granular materials before the adsorption is 0.05 HF-mg/NaF-g, and the SV of the outlet gas of the sodium fluoride packed column 5 is 397/h.

The hydrogen fluoride concentration in fluorine gas thus obtained was 0.1 ppm by volume or less, and was approximately 1/2700 or less of the hydrogen fluoride concentration in the fluorine gas obtained in Comparative Example 1.

However, from around the time when the adsorption amount of the hydrogen fluoride to the sodium fluoride pellets of the sodium fluoride packed column 5 reached 5.5% by mass of the mass of the sodium fluoride, the pressure inside the sodium fluoride packed column 5 started to sharply increase and the outlet gas did not flow out of the sodium fluoride packed column 5.

When the sodium fluoride pellets were observed in the same manner as in Example 1, joining of the pellets occurred in the sodium fluoride pellets of the sodium fluoride packed column 5. In detail, for the sodium fluoride pellets arranged in a portion close to the introduction port of the hydrogen fluoride-containing gas of the inside of the sodium fluoride packed column 5 (range of approximately ⅓ of the central axis length of the sodium fluoride packed column 5), joining of the pellets occurred. For a portion other than the portion close to the introduction port described above of the sodium fluoride packed column 5, no joining of the sodium fluoride pellets occurred.

It is considered that, when the flow rate of the hydrogen fluoride-containing gas is low, the supply rate of the hydrogen fluoride also becomes low, and therefore the hydrogen fluoride is likely to be adsorbed on the sodium fluoride pellets arranged in a portion closest to the introduction port of the hydrogen fluoride-containing gas of the inside of the sodium fluoride packed column 5. As a result, it is considered that the sodium fluoride pellets arranged in the portion closest to the introduction port of the hydrogen fluoride-containing gas adsorbed a large amount of the hydrogen fluoride, and therefore powdering or joining occurred, and clogging occurred, so that a gas flow path was blocked.

### REFERENCE SIGNS LIST

1: hydrogen fluoride gas supply section
2: dilution gas supply section
5: sodium fluoride packed column
10: sodium fluoride packed column
15: heat treatment atmospheric gas supply section
17: sodium fluoride packed column

1. A method for removing hydrogen fluoride from gas to be treated containing the hydrogen fluoride, comprising:
a first adsorption step of introducing the gas to be treated into a first adsorption treatment section including sodium fluoride, bringing the gas to be treated into contact with the sodium fluoride of the first adsorption treatment section, and allowing the hydrogen fluoride in the gas to be treated to adsorb on the sodium fluoride of the first adsorption treatment section to obtain first adsorption-treated gas, the first adsorption-treated gas being the gas to be treated in which a hydrogen fluoride concentration has been lowered; and
a second adsorption step of introducing the first adsorption-treated gas into a second adsorption treatment section including sodium fluoride, bringing the first adsorption-treated gas into contact with the sodium fluoride of the second adsorption treatment section, and allowing the hydrogen fluoride in the first adsorption-treated gas to adsorb on the sodium fluoride of the second adsorption treatment section to obtain second adsorption-treated gas, the second adsorption-treated gas being the first adsorption-treated gas in which a hydrogen fluoride concentration has been lowered, wherein
a temperature of the sodium fluoride of the first adsorption treatment section when the gas to be treated is brought into contact with the sodium fluoride in the first adsorption step is higher than a temperature of the sodium fluoride of the second adsorption treatment section when the first adsorption-treated gas is brought into contact with the sodium fluoride in the second adsorption step,
in the first adsorption step, a ratio of a mass of the hydrogen fluoride per unit time in the gas to be treated introduced into the first adsorption treatment section to a mass of the sodium fluoride of the first adsorption treatment section before the adsorption is 0.05 HF-mg/NaF-g/h or more and 70 HF-mg/NaF-g/h or less, and
in the second adsorption step, a ratio of a mass of the hydrogen fluoride per unit time in the first adsorption-treated gas introduced into the second adsorption treatment section to a mass of the sodium fluoride of the second adsorption treatment section before the adsorption is 0.001 HF-mg/NaF-g/h or more and 5 HF-mg/NaF-g/h or less.

2. The method for removing hydrogen fluoride according to claim 1, further comprising:
a desorption step of heating at least one of the sodium fluoride of the first adsorption treatment section used in the first adsorption step and the sodium fluoride of the second adsorption treatment section used in the second adsorption step under heat treatment atmospheric gas, and desorbing the hydrogen fluoride at a rate of 10 mg or less per gram of the sodium fluoride before the adsorption and 10 mg or less per minute in each of the sodium fluoride of the first adsorption treatment section and the sodium fluoride of the second adsorption treatment section; and
an exchange step of exchanging at least one of the sodium fluoride of the first adsorption treatment section used in the first adsorption step and the sodium fluoride of the second adsorption treatment section used in the second adsorption step with the sodium fluoride from which the hydrogen fluoride has been desorbed in the desorption step.

3. The method for removing hydrogen fluoride according to claim 1, wherein the temperature of the sodium fluoride of the first adsorption treatment section when the gas to be treated is brought into contact with the sodium fluoride in the first adsorption step is 50° C. or more and 120° C. or less.

4. The method for removing hydrogen fluoride according to claim 1, wherein the temperature of the sodium fluoride of the second adsorption treatment section when the first adsorption-treated gas is brought into contact with the sodium fluoride in the second adsorption step is −10° C. or more and less than 50° C.

5. The method for removing hydrogen fluoride according to claim 1, wherein, in the first adsorption step, a ratio of a mass of the hydrogen fluoride in the gas to be treated introduced into the first adsorption treatment section to the mass of the sodium fluoride of the first adsorption treatment section before the adsorption is 10 HF-mg/NaF-g or more and 100 HF-mg/NaF-g or less.

6. The method for removing hydrogen fluoride according to claim 1, wherein, in the second adsorption step, a ratio of a mass of the hydrogen fluoride in the first adsorption-treated gas introduced into the second adsorption treatment section to the mass of the sodium fluoride of the second adsorption treatment section before the adsorption is 100 HF-mg/NaF-g or less.

7. The method for removing hydrogen fluoride according to claim 2, wherein a heating temperature of the desorption step is 150° C. or more and 240° C. or less.

8. The method for removing hydrogen fluoride according to claim 2, wherein the heat treatment atmospheric gas is at least one of nitrogen gas, helium, argon, oxygen gas, and air.

9. The method for removing hydrogen fluoride according to claim 1, wherein the hydrogen fluoride concentration in the second adsorption-treated gas discharged from the second adsorption treatment section is 0.01 ppm by volume or more and 250 ppm by volume or less.

10. The method for removing hydrogen fluoride according to claim 1, wherein the gas to be treated contains at least one of fluorine gas, chlorine monofluoride, chlorine trifluoride, chlorine pentafluoride, bromine trifluoride, bromine pentafluoride, bromine heptafluoride, iodine trifluoride, iodine pentafluoride, iodine heptafluoride, tungsten hexafluoride, silicon tetrafluoride, nitrogen trifluoride, and sulfur tetrafluoride, and hydrogen fluoride.

11. The method for removing hydrogen fluoride according to claim 1, wherein the sodium fluoride of the first adsorption treatment section and the sodium fluoride of the second adsorption treatment section are obtained by tableting and molding sodium fluoride powder.

12. The method for removing hydrogen fluoride according to claim 2, wherein the temperature of the sodium fluoride of the first adsorption treatment section when the gas to be treated is brought into contact with the sodium fluoride in the first adsorption step is 50° C. or more and 120° C. or less.

13. The method for removing hydrogen fluoride according to claim 2, wherein the temperature of the sodium fluoride of the second adsorption treatment section when the first adsorption-treated gas is brought into contact with the sodium fluoride in the second adsorption step is −10° C. or more and less than 50° C.

14. The method for removing hydrogen fluoride according to claim 2, wherein, in the first adsorption step, a ratio of a mass of the hydrogen fluoride in the gas to be treated introduced into the first adsorption treatment section to the mass of the sodium fluoride of the first adsorption treatment section before the adsorption is 10 HF-mg/NaF-g or more and 100 HF-mg/NaF-g or less.

15. The method for removing hydrogen fluoride according to claim 2, wherein, in the second adsorption step, a ratio of a mass of the hydrogen fluoride in the first adsorption-treated gas introduced into the second adsorption treatment section to the mass of the sodium fluoride of the second adsorption treatment section before the adsorption is 100 HF-mg/NaF-g or less.

16. The method for removing hydrogen fluoride according to claim 7, wherein the heat treatment atmospheric gas is at least one of nitrogen gas, helium, argon, oxygen gas, and air.

17. The method for removing hydrogen fluoride according to claim 2, wherein the hydrogen fluoride concentration in the second adsorption-treated gas discharged from the second adsorption treatment section is 0.01 ppm by volume or more and 250 ppm by volume or less.

18. The method for removing hydrogen fluoride according to claim 2, wherein the gas to be treated contains at least one of fluorine gas, chlorine monofluoride, chlorine trifluoride, chlorine pentafluoride, bromine trifluoride, bromine pentafluoride, bromine heptafluoride, iodine trifluoride, iodine pentafluoride, iodine heptafluoride, tungsten hexafluoride, silicon tetrafluoride, nitrogen trifluoride, and sulfur tetrafluoride, and hydrogen fluoride.

19. The method for removing hydrogen fluoride according to claim 2, wherein the sodium fluoride of the first adsorption treatment section and the sodium fluoride of the second adsorption treatment section are obtained by tableting and molding sodium fluoride powder.
